(19) United States
(12) Patent Application Publication
(10) Pub. No.: US 2002/0100809 A1
(43) Pub. Date: Aug. 1, 2002

(54) Data storage device with optical interface

(76) Inventor: Ho-Lung Lu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/774,034

(22) Filed: Jan. 31, 2001

(51) Int. Cl. G06K 19/06

(52) U.S. Cl. 235/492

(57) ABSTRACT

A data storage device with optical interface comprises a data storage medium, an optical transmission means, and a power unit. The data storage medium is a magnetic or a semiconductor medium. The optical transmission means is a bi-directional infrared ray transceiver. The power unit provides necessary power for the said device to work. The said device, when wirelessly connecting to a handheld client system capable optical transmission, reads writes, and deletes data on the said storage medium according to the operations requested by the client system. Thus, by replacing storage medium the said device can expmd the handheld system to almost infinity. This advantage is most beneficial when a PC system is not near by.

### FIELD OF THE INVENTION

The present invention relates to a data storage device built with an optical transmission interface, and especially to a device performing a bi-directional transmission between the said device and a portable system capable of doing optical transmission.

### BACKGROUND OF THE INVENTION

In general, the prior art data storage mediums (for example, smart cards or compact flash cards) are integrally formed with portable computer devices or pocket personal computers to be as an integral body. However, no device can perform a bi-directional transmission between the data storage medium and the portable computer device, such as a portable computer device, a pocket personal computer or a notebook computer, by a wireless way.

Therefore, there is an eager demand for a novel device which can improve the prior art defects as described hereinabove,

### SUMMARY OF THE INVENTION

Accordingly, the primary object of the present invention is to provide an optical interfacing data storage device, wherein a data storage medium is integrally installed with an optical data output/input interface unit. The optical data output/input interface unit is formed by connecting an optical transmission/receiving module with a microprocessor built with programs therein for performing a bi-directional transmission between the data storage medium and the portable computer device.

Another object of the present invention is to provide an optical interfacing data storage device, wherein the present invention is portable conveniently and can be connected to the portable computer device without needing any transmission line.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention,

FIG. 2 is an assembled view of the optical data output/input interface unit in the present invention.

### DETAILED DESCRIPTION OF THE PREFERRED EMBODIMENTS

To further understand the present invention, a detail description of the present invention will be described in the following with the appended drawings. Those skilled in the art may completely understand the objects, characteristics and features of the present invention from these descriptions. However, those descriptions and the appended drawings are only used to describe the present invention instead of being used to confine the spirit and scope of the present invention defined in the appended claims.

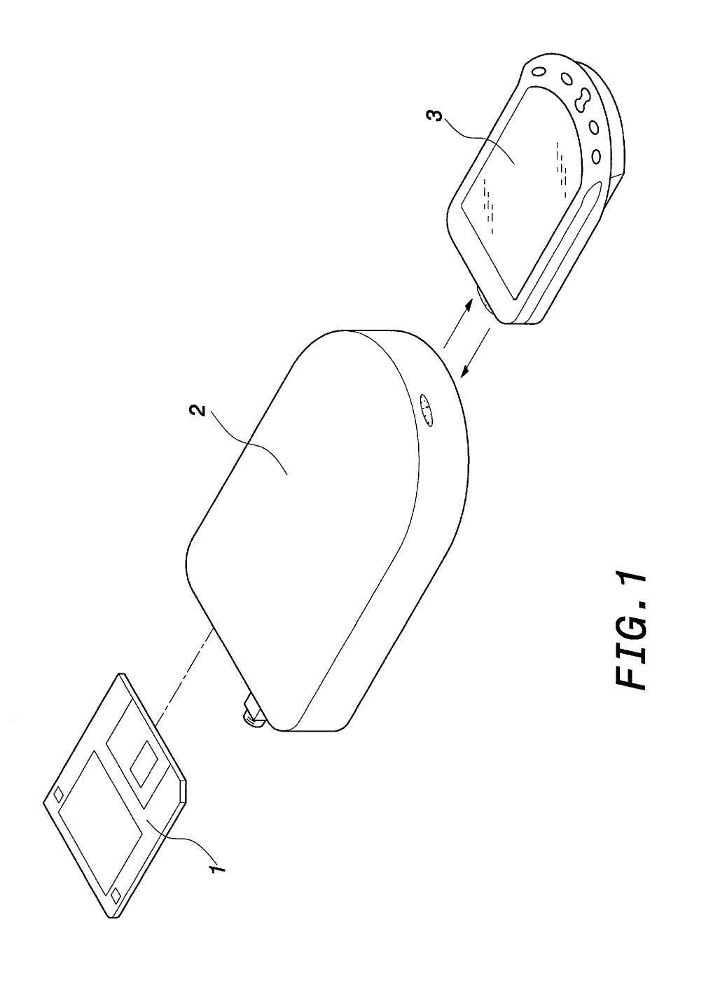

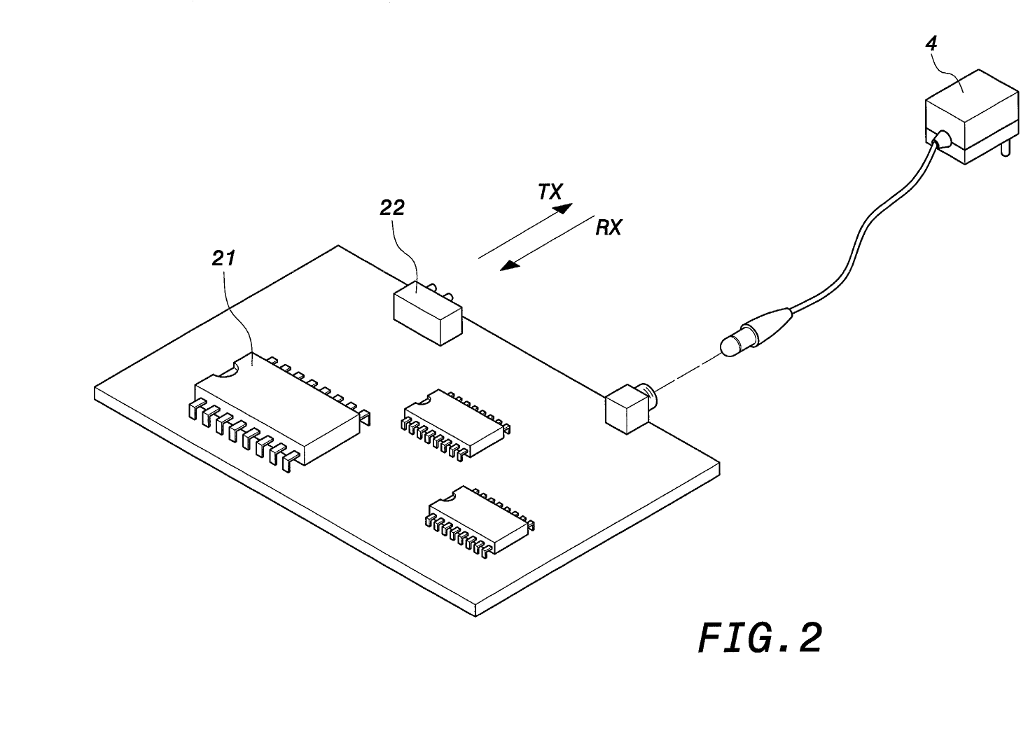

Referring to FIGS. 1 and 2, the optical interfacing data storage device of the present invention is illustrated. The optical interfacing data storage device includes a data storage medium 1, an optical data output/input interface unit 2, a portable computer device 3 and a power unit 4.

The data storage medium 1 is a magnetic or a semiconductor medium for accessing data, wherein the magnetic medium may be a floppy disk and a floppy disk drive. The semiconductor medium is a memory chipset, a compact flash card (CF card), a smart card (CM card), etc.

The portable computer device is a palm/pocket personal computer or a portable computer device, or a notebook computer.

The optical data output/input interface unit 2 is formed by connecting a microprocessor 21 built with programs therein with an optical transmission/receiving module. The data storage medium 1 is bi-directional communicated with the portable computer device 3 and has the functions of reading (loading), writing (storage) or deleting data files. The details are described in the following.

1. The function of reading: The file read by the data storage medium 1 is loaded into the portable computer device 3 for being used.

2 The function of writing: the file is stored to the data storage medium 1 from the portable computer device 3

3. The function of deleting data file: the portable computer device 3 deletes the files in the data storage medium 1.

The power unit 4 is a battery or an alternative current power which is rectified through a transformer for providing working power.

Therefore, the present invention has the following advantages:

(1) A bi-directional transmission way is performed between the data storage medium and the portable computer device through an optical wireless way.

(2) The present invention is portable conveniently.

(3) The portable computer device is performed without needing any transmission line.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A data storage device with optical interface comprising:
a data storage medium being a magnetic or a semiconductor medium;
an optical transmission means, through which a portable system can operate the said device to read, write, and delete data on the storage medium; and
a power unit for providing working power

2. The optical interfacing data storage device as claimed in claim l, wherein the magnetic medium is a floppy disk drive with floppy diskette.

3. The optical interfacing data storage device as claimed in claim 1, wherein the semiconductor medium is selected from one of a group containing a memory chipset, a compact flash card, or a smart card

4. The optical interfacing data storage device as claimed in claim 1, wherein the portable system is capable of doing optical transmission, and is selectable from one of a group containing a palm, pocket personal computer, a portable computer, or a notebook computer.

5 The optical interfacing data storage device as claimed in claim 1, wherein the power unit is a battery or an external adaptor.

6. The optical interfacing data storage device as claimed in claim 1, wherein the optical transmission means consists of an optical transceiver module and a micro controller built with necessary programs to handle both optical transmission and operations on the storage medium.
